(19) United States
(12) Patent Application Publication
(10) Pub. No.: US 2019/0386984 A1
(43) Pub. Date: Dec. 19, 2019

(54) TWO-FACTOR AUTHENTICATION THROUGH ULTRASONIC AUDIO TRANSMISSIONS

(71) Applicant: PAYPAL, INC., San Jose, CA (US)

(72) Inventors: Nisarg Mahesh Thakkar, Mumbai (IN); Amriteya Pandey, Austin, TX (US); Sakshi Ganeriwal, Kolkata (IN); Vivek Gupta, Ballabhgarh (IN)

(21) Appl. No.: 16/008,314

(22) Filed: Jun. 14, 2018

(51) Int. Cl. H04L 29/06; H04L 9/32; G06Q 20/38

(52) U.S. Cl. CPC H04L 63/0853; H04L 63/083; H04L 2463/082; H04L 63/0838; G06Q 20/385; H04L 9/3226

(57) ABSTRACT

There is provided systems and methods for two-factor authentication through ultrasonic audio transmissions. A user may utilize a first device request to process a transaction electronically by providing an electronic payment using an online service provider. When utilizing the service provider, authentication for the user's payment instrument and/or the user's account with service provider may require two-factor authentication using a one-time password that is unknown to the user and generated for the specific authentication request. The password may be generated and sent to a second device registered for the user and/or their account. The second device may process an ultrasonic handshake request with the first device, and may respond to the first device with an ultrasonic communication including the password. The first device may then automatically enter the password to the two-factor authentication process.

### TECHNICAL FIELD

The present application generally relates to electronic security and authentication, and more specifically to two-factor authentication through ultrasonic audio communications between devices.

### BACKGROUND

Users may utilize an online service provider that provides electronic transaction processing through a user's digital wallet having funding sources. The online service provider may be integrated with merchants, so that the service provider may process and complete transactions between merchants and users. For example, in a checkout portal or interface of a merchant's website or dedicated application, a user shopping with the merchant may be provided with an option to complete checkout and process a transaction using the user's digital wallet through the online service provider. To prevent unauthorized use of the digital wallet, the online service provider typically requires the user to first be authenticated, such as by having the user enter a password or PIN. However, passwords or PINs can be obtained by fraudsters, such as through theft, guessing, phishing, or other means. In order to provide additional security, two-factor authentication may be utilized, which can require the user to further enter a randomly generated password. However, present processes for two-factor authentication can be time consuming, error prone, and labor intensive when entering received codes, and therefore may not be required by some service providers , thereby increasing potential risk, or result in frustration by the user that may lead to the user abandoning a transaction or being locked out of an account.

### BRIEF DESCRIPTION OF THE DRAWINGS

FIG. 1 is a block diagram of a networked system suitable for implementing the processes described herein, according to an embodiment;

FIG. 2 is an exemplary real-world environment where a user may utilize ultrasonic communications between two devices to perform two-factor authentication without interfering with another device, according to an embodiment;

FIG. 3A is an exemplary communication flowchart for a simplified two-factor authentication process through ultrasonic communications, according to an embodiment;

FIG. 3B is an exemplary communication flowchart for performing a handshake and transmitting a one-time password for two-factor authentication through ultrasonic communications when two associated devices for an account are present, according to an embodiment;

FIG. 3C is an exemplary communication flowchart for performing a handshake and transmitting a one-time password for two-factor authentication through ultrasonic communications when multiple associated device for multiple accounts are present, according to an embodiment;

FIG. 3D is an exemplary application interface requesting a one-time password for two-factor authentication through ultrasonic communications, according to an embodiment;

FIG. 3E is an exemplary application interface after entering a one-time password for two-factor authentication received through ultrasonic communications, according to an embodiment;

FIG. 4 is an exemplary process flowchart for two-factor authentication through ultrasonic audio transmissions, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for two-factor authentication through ultrasonic audio transmissions. Systems suitable for practicing methods of the present disclosure are also provided.

Two-factor authentication may be used to provide additional security to electronic transaction processing by providing a process to enter an unknown and/or randomly generated password or other code during the transaction processing, in addition to a first authenticator, such as a password or PIN. In order to provide hands free and automatic entry of the passcode, two computing devices, such as personal computers, mobile phones, laptops, wearable computing devices, tablet computers, or other user devices, may interact through audio communications. The devices may interact through ultrasonic audio waves that may be imperceptible to the average human ear. Audio communications may correspond to audible and/or inaudible sound or pressure waves that are propagated through air. For example, audible sound waves may have a frequency in the normal or average range of human hearing, such as between 20 Hz to 20 kHz. Conversely, inaudible sound waves may correspond to sound pressure waves below or above the normal or average limit of human hearing, such as infrasonic sound waves having a frequency below 20 Hz or ultrasonic sound waves above 20 kHz. The devices may interact to perform a handshake and negotiate a security mechanism (e.g., encryption through a shared secret, such as an account identifier), and may then exchange the two-factor authentication password using the security mechanism. For example, a first device may require the two-factor authentication password during electronic transaction processing using a user's account, and a second nearby device previously associated with the user's account may receive the password and emit a sound wave communication having the password encoded and encrypted into the sound wave. The password may be decoded and decrypted from the received audio wave communication by the first device requiring the password, and may then be automatically entered for the two-factor authentication process. In this manner, two-factor authentication may be provided in a secure manner without requiring laborious and error prone entry of the password during the authentication process.

A service provider, such as PayPal® or other online payment provider or transaction processor service, may provide payments and other services on behalf of users, merchants, and other entities. The payment provider may provide payment accounts and/or payment processes to users that allow users to send and/or receive payments between the user and another user/merchant. For example, a user may wish to provide a payment for a transaction with a user/merchant, transfer money to another family/friend, engage in a transaction previously generated and provided to the user, initiate a transaction with another entity, or perform another process. A merchant may similarly send and/or receive payments between the merchant and another user/merchant, which may include receiving payment for transactions, providing payments to employees and/or for business expenses, transfer money between accounts, or perform further transaction processing. Other entities, such as charitable organizations and businesses, may also utilize the payment provider, for example, to receive donations from various parties and/or pay business expenses. The online payment provider may be utilized to perform such electronic transaction processing. Additionally, the online payment provider may provide payment accounts and digital wallet services, which may offer account services to send, store, and receive money, process financial instruments, and/or provide transaction histories. The online payment provider may offer further services, such as extension of credit, credit history review, account establishment and maintenance, and other financial and personal services.

The payment provider may further provide a digital wallet to the user through the payment account, where the digital wallet may include one or more financial instruments that the user may use during transaction processing. Thus, the payment provider may further include additional transaction management services, as well as account services for use with the payment provider and accessible through a device application, such as a browser application, dedicated application of the payment provider, and/or other application (e.g., merchant application) utilizing the processes and features provided by the payment provider. However, in other embodiments, transaction processing service using the online payment provider and the digital wallet may be integrated into the merchant's website/dedicated application. Accounts with the payment provider may correspond to a digital wallet, as well as a payment account, where a holder of the account may send and receive payments and engage in transaction processing. For example, payment accounts with a payment provider may allow the user to send and receive money for transactions, transfers, and other financial actions. The accounts of users may include personal, device, and financial information, as well as other information that may be determined by or requested from the payment provider. Additionally, the user may specify authentication credentials, such as a login name, password, and/or personal identification number (PIN) for use of the account.

Merchants may sell items (which can include physical goods, digital goods, and/or services) to buyers through an online marketplace, which may be accessible through a web browser of the user (e.g., a merchant website and/or a website of another online service provider offering the online marketplace) or a dedicated application for the merchant. A user may select one or more items for purchase, for example, by entering the items into a transaction or shopping cart for the merchant's marketplace (e.g., through selection of the items for purchase with the merchant) using a device of the user to access the merchant's marketplace. In order to complete a purchase for the items, the user may be required to checkout for the items and provide payment for the items. The online payment provider may provide payment services including payment accounts for use during transaction processing to provide a payment. Thus, the user may engage in a transaction with the merchant using a payment account and/or digital wallet with the payment provider, where the user may enter payment account information during checkout and transaction processing to use the payment instrument for the transaction.

During electronic transaction processing, various authentication processes may be required, including entry of an unknown and/or randomly generated password for the user's account that is provided during the specific instance of electronic transaction processing. For example, the payment account may be linked to a financial instrument, such as a debit/credit card, bank account, or other financial source. The payment provider may process the financial instrument of the user to provide payment to the merchant, for example, by withdrawing funds from a bank account or processing a debit/credit card to provide the payment to the merchant. The user may be required to authenticate usage of the payment account during transaction processing and payment, for example, by providing authentication credentials, such as an email, username, password, PIN, and/or performing a two or more step (multi-factor) authentication. A merchant may also provide sales through a physical merchant location, such as a brick and mortar store, where the merchant provides transaction processing through the online payment provider. Thus, similar payment processing may be done by the user through the user's device at a physical merchant location, where the user's device may interface with a merchant device at the merchant's physical location in order to perform transaction processing and payment services through the online payment provider.

After initial identification of the user's account and/or financial instrument (as well as any authentication through known information, such as a user name and/or password/PIN), the payment provider may further require completion of a two-factor authentication process. The two-factor authentication process may require entry of a password or passcode that is unknown to the user prior to the start of the two-factor authentication process, such as a randomly generated one-time use password that is sent to a known device of the user. The device that the one-time password is sent to may be previously registered with the user's account so that the device is known to the payment provider. The device is further separate from and different from the device that requires the one-time password entered for the two-factor authentication process. For example, the user may utilize a first device, such as a personal computer, to access a website of a merchant and engage in electronic transaction processing that requires the two-factor authentication process to approve a payment using a payment instrument of the user in a digital wallet provided by the payment provider. Instead of requiring manual entry of the one-time password to the authentication process, the payment provider may identify the user's account (e.g., using an entered account identifier, user name, email, etc., as well as any known authentication information, such as a password), and may determine an identifier for a second device registered with the user's account, such as a mobile smart phone or other type of computing device. The second device may include an application associated with the service provider, such as a transaction processing and payment application used for electronic transaction processing and account access on the second device.

Once the second device is determined by the payment provider, the payment provider may determine or generate a one-time password for use in authenticating the user for use of the account using the second device registered for the account and transmit the one-time password to the second device. In certain embodiments, the payment provider may request the one-time password from a banking entity or other online resource corresponding to the selected payment instrument for the transaction, where the online resource requires the two-factor authentication process to use the payment instrument and provides the one-time password to the payment provider. In other embodiments, the payment provider may generate a one-time password for use with the payment provider in processing the transaction using the two-factor authentication.

In response to receiving the one-time password, the second device may activate a microphone or other audio input component/process that is capable of detecting audio communications by the second device, including ultrasonic audio communications. When the first device receives and displays a webpage or other output data for the two-factor authentication process, the first device may begin listening for a handshake request from the second device, where the first device activates an audio detection component. The second device may transmit ultrasonic audio communications including the handshake request, which may be encrypted. In such embodiments, the first device may then decrypt the handshake data, confirm the handshake, and transmit a notification to the second device to send the one-time password through audio communications.

In other embodiments, the first device may begin transmitting a handshake request using a speaker or other audio output component of the first device. The handshake request may include some handshake data, such as a “hot” word or other data that may activate another device's audio listening process and/or identify the first/second device to another device. A “hot” word may be defined as a word, phrase, text, code, or other data that may cause activation of a device (e.g., the second device) and/or verification of a handshake request by the device, in some embodiments. The handshake request may include encrypted data, which may be encrypted using an account identifier for the user's account so that the handshake request may only be decrypted and processed by another device that knows the account identifier, such as the second device. In other embodiments, another security mechanism may be used for encryption of the handshake data, such as a shared secret or key between the first device and the second device. The handshake request may be encoded into an audio pattern or wave after encryption of the handshake data using the account identifier.

Once the first device processes the handshake request, the first device may wait for password data. The second device that had previously activated its microphone based on receiving the one-time password may detect and receive the handshake request or the confirmation and password request from the first device, and may complete the handshake request. The second device may then encode the one-time password into an audio pattern or wave. Prior to encoding the one-time password into the audio pattern, the second device may also encrypt the password using the negotiated and/or shared security key or mechanism, such as the account identifier. In other embodiments, the payment provider may encrypt the one-time password and/or encode the encrypted one-time password into a sound wave for output by the second device. Thus, the service provider may provide an audio file for output by the second device after performing the handshake described above. The second device may then begin broadcasting the audio communication having the one-time password.

The first device may listen for the audio communications from the second device after accessing the two-factor authentication page or process and outputting the handshake request. The first device may detect the audio communication from the second device that includes the one-time password for the two-factor authentication process. The first device may transmit an audio file recording the audio communication from the second device to the website and/or processing entity that requests the two-factor authentication process and one-time password. The processing entity may then decode the recorded audio communication and may decrypt the password from the decoded audio file to receive the one-time password, which may then be entered to a field for the one-time password with the two-factor authentication process. In other embodiments, the first device may perform the decoding and decrypting of the recorded audio file, and may then directly enter the password to the field of the two-factor authentication process requiring the password. Once entered, the password may be processed to determine whether the password matches the password generated for the two-factor authentication process, which may include the payment provider and/or the processing entity for the website/application requesting the two-factor authentication process receiving the one-time password and verifying the one-time password.

In response to the first device receiving the audio communications with the one-time password, the first device may deactivate its microphone and stop listening for audio communications. The first device may do so in response to verifying that the audio communication is from the second device through using the account identifier or other shared key or security mechanism to verify the data that is encrypted in the audio communications from the second device. The first device may further send an acknowledgement response through audio communications to the second device that may request that the second device deactivate its microphone and end broadcasting of the audio communications having the one-time password. The acknowledgement response may be encoded in an audio pattern, and may also be encrypted using the account identifier for verification by the second device that the acknowledgement is from the first device. The second device may receive the acknowledgement response from audio communication by the first device, and may decode and decrypt the acknowledgement response. Once processed, the second device may then deactivate its microphone and may end broadcasting of the audio communications having the one-time password.

In the event that the first device and the second device are in an environment with multiple other devices, the first device and the second device may ensure that the other devices listening are unable to determine the two-factor authentication password through encryption of the audio communications between the first device and the second device using a shared secret. The shared secret may correspond to the account identifier known by the first device and the second device. Additionally, the first device and the second device may discard received audio communications that have not been encrypted with the account identifier or other encryption mechanism. For example, after activating its respective microphone as discussed herein, the first device and the second device may listen for audio communications, which may then be attempted to be decrypted using the account identifier. In the event that the communications cannot be verified using the account identifier, the first device and the second device may discard those audio communications.

Additionally, the first device may display the two-factor authentication process for a website within an HTML inline frame element having a webpage of another website or online resource that includes the two-factor authentication process within the webpage, for example, with one or more fields for entry of data including the one-time password. The webpage in the inline frame element may then receive the one-time password and process the password. However, the first device may access a website and/or use a web browser that does not support HTML inline frame elements, such as a inline frame element on a website that display a webpage for the two-factor authentication process and processes audio communications from the second device that include the one-time password for two-factor authentication. In order to provide support for the one-time password received through the audio communications, the one-time password may be displayed in another interface element with an option, such as a button corresponding to an executable process, to copy the one-time password determined from the audio communications to a clipboard. The user may then copy the one-time password from the clipboard and paste the password into a field for the two-factor authentication process displayed in the initial webpage (e.g., the webpage for the transaction and not a webpage in an inline frame element of the service provider that processes the password).

Thus, a user may perform two-factor authentication in a more efficient and seamless manner on a first device by using a second device to perform audio communications of a one-time password to the first device. This increases speed in authenticating the user using known devices, and prevents erroneous entry of one-time passwords that can be long and unknown to the user. Moreover, as the devices utilize known data between the devices for encryption, the audio communications are protected from unauthorized reception and misappropriate of the data, thereby increasing security in utilizing these communications.

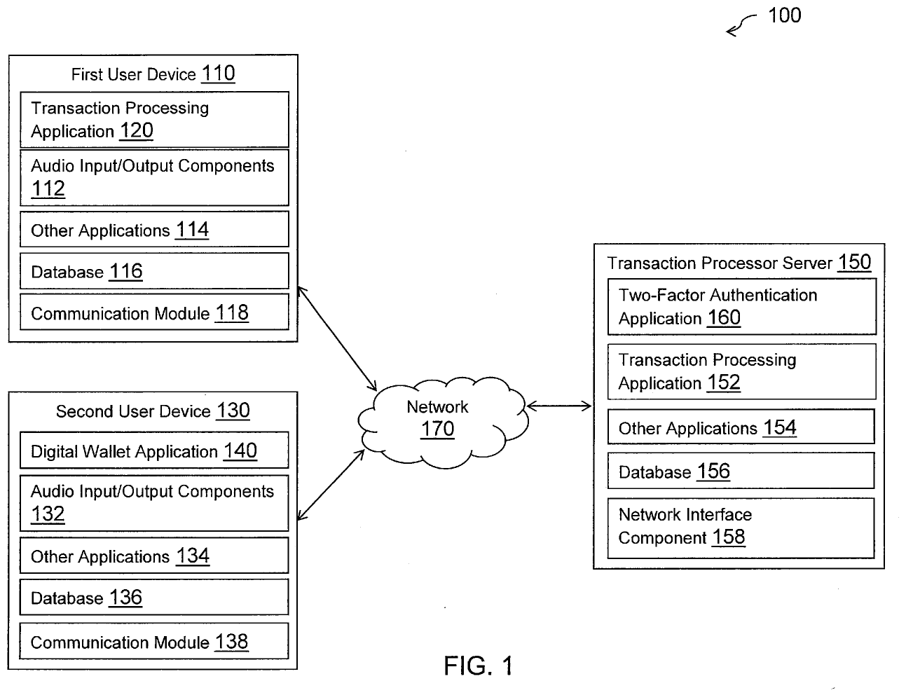

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a first user device 110, a second user device 130, and a transaction processor server 150, in communication over a network 170. A user (not shown) may utilize first user device 110 to engage in a transaction with an online merchant or other online entity (not shown) through an application executing on first user device 110. The user may select items for purchase and enter a checkout process with the merchant. The checkout process may allow for transaction processing using transaction processor server 150, which may utilize a two-factor authentication process that requires entry of an unknown and/or randomly generated password communicated to a known device of the user, such as second user device 130, in addition to a first authenticator, such as a known password or PIN. For example, the user may select a payment instrument in a digital wallet serviced by transaction processor server 150, where a financial entity associated with the payment instrument may require two-factor authentication through a one-time password. Second user device 130 may receive the one-time password, and may communicate with first user device 110 through audio communications to provide the one-time password to first user device 110. First user device 110 may then process the one-time password with the two-factor authentication process through the application processing the transaction. Transaction processor server 150 may receive the one-time password and/or communicate the one-time password to the financial entity associated with the payment instrument for processing.

First user device 110, second user device 130, and transaction processor server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

First user device 110 may be implemented as a communication device that may utilize appropriate hardware and software configured for wired and/or wireless communication with second user device 130 and/or transaction processor server 150. For example, in one embodiment, first user device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may be used and function similarly.

First user device 110 of FIG. 1 contains a transaction processing application 120, audio input/output components 112, other applications 114, a database 116, and a communication module 118. Transaction processing application 120 and other applications 114 may correspond to executable processes, procedures, and/or applications with associated hardware. In other embodiments, first user device 110 may include additional or different modules having specialized hardware and/or software as required.

Transaction processing application 120 may correspond to one or more processes to execute software modules and associated devices of first user device 110 to initiate and/or generate transactions to purchase items, as well as request transaction processing through transaction processor server 150. In this regard, transaction processing application 120 may correspond to specialized hardware and/or software utilized by a user to view items for purchase from a merchant associated with second user device 130 and select one or more items to purchase in a transaction. Once a transaction is generated, transaction processing application 120 may be used to request checkout and transaction processing for the transaction. In various embodiments, the merchant may provide checkout and payment processing using services provided by transaction processor server 150. Where the user has an account with transaction processor server 150 and/or uses a payment instrument that transaction processor server 150 processes with an online financial entity, such as a bank for a debit/credit card, transaction processing application 120 may utilize such account.

Transaction processing application 120 may provide one or more authentication mechanisms, including a two-factor authentication mechanism that additionally requires a one-time password to be entered to a field displayed in an interface. The user may provide user information (e.g., name, shipping address, birthdate, and/or other consumer specific information) and/or financial information (e.g., a financial account, shipping address, etc.) during the checkout process. Thus, the checkout interface may be displayed during electronic transaction processing and completing the checkout process. Transaction processing application 120 may communicate the user and/or financial information to transaction processor server 150 during the checkout process, where a secure communication channel (e.g., secure TCP/IP communications between first user device 110 and transaction processor server 150) may be established to transmit the information to transaction processor server 150. The secure communication channel may be established for the checkout process to transmit data entered to one or more fields of the checkout interface.

In various embodiments, transaction processing application 120 may correspond to a general browser application configured to retrieve, present, and communicate information over the Internet (e.g., utilize resources on the World Wide Web) or a private network. For example, transaction processing application 120 may provide a web browser, which may send and receive information over network 170, including retrieving website information, presenting the website information to the user, and/or communicating information to the website, including electronic communications and associated information. However, in other embodiments, transaction processing application 120 may include a dedicated application of transaction processor server 150 or other entity, which may be configured to send and receive electronic communications and engage in electronic transaction processing. Thus, the user associated with first user device 110 may utilize transaction processing application 120 to engage in further transactions with the merchant/seller associated with second user device 130.

During transaction processing, transaction processing application 120 may display the checkout interface that requires a one-time password to be entered to a field of a two-factor authentication process. Transaction processing application 120 may display the two-factor authentication process in a webpage or other interface, which may include an HTML inline frame that displays the process in a webpage for transaction processor server 150 or the financial entity associated with the payment instrument requiring the two-factor authentication process. The two-factor authentication process may also be displayed in a webpage or interface associated with the merchant requesting transaction processing. Once displayed, a one-time password may be sent to second user device 130 for audio communication to first user device 110.

After displaying the two-factor authentication process, transaction processing application 120 may begin listening for a handshake request or broadcasting a handshake request having handshake data, such as a hot word or other identifier that may identify first user device 110 and/or second user device 130 for data exchange of the one-time password. In order to broadcast the handshake request, transaction processing application 120 may begin broadcasting or transmitting an audio pattern, code, or other audio data that has the handshake data encoded into the audio communications. The audio communications may be infrasonic, ultrasonic, or within the range of human hearing. Transaction processing application 120 may also activate a microphone of first user device 110 in order to begin listening for audio communications including the one-time password. In other embodiments, transaction processing application 120 may activate another on-device audio detection component or connected audio detection component that may be capable of detecting broader ranges of audio communications, such as infrasonic and/or ultrasonic audio detection components capable of detecting audio frequency ranges that may be outside of a normal sound frequency ranges used by human speech and/or hearing. For example, an ultrasonic audio detector of audio input/output components 112 may detect ultrasonic audio communications from second user device 130. Additionally, transaction processing application 120 may instead listen for an audio handshake request from second user device 130, and, once received, may decrypt the data, verify the handshake data, and transmit a confirmation of the handshake data to second user device 130, where the confirmation requests that second user device 130 transmit the one-time password.

The handshake data may also be encrypted using a shared secret, such as a shared encryption key, a known account code or number, or tokenized data shared between first user device 110 and second user device 130, that allows the devices to verify each other and/or decrypt the handshake request in the audio communications and verify first user device 110 to second user device 130. For example, an account identifier for an account or payment instrument that is being processed in the transaction by transaction processor server 150 may be utilized to encrypt the handshake data. Transaction processing application 120 may receive an audio file having an audio pattern with the handshake data encoded into the audio pattern. However, in other embodiments, first user device 110 may receive or determine the handshake data and may encrypt the handshake data using the account identifier, key, or other security mechanism. Once encrypted, transaction processing application 120 may then encode the encrypted handshake data into an audio pattern/signal, and may begin transmitting the audio communications for receipt by second user device 130.

Once processed, transaction processing application 120 may receive second audio communications from second user device 130 that include the one-time password transmitted in response to the handshake request. The audio communications may include the one-time password encrypted using the negotiated or selected security mechanism, such as the account identifier, as discussed herein. The audio communications including the one-time password may further have the encrypted password encoded into an audio pattern or other audio data, and may be transmitted using infrasonic, ultrasonic, or audible frequencies. Transaction processing application 120 may provide the receive audio communications to the entity processing the two-factor authentication, or may decode the encrypted password from the audio communications, decrypt the encrypted password, and enter the decrypted password as text to a field of the two-factor authentication process.

Where the two-factor authentication process is provided in an inline frame webpage element, the two-factor authentication process may provide for the decoding and decrypting of the audio communications so that the password may be entered. However, where an inline frame element is not provided, transaction processing application 120 may provide a process with an interface element (e.g., selectable option) to place the decrypted password into a notepad or other text processing application and copy-paste the password from the notepad to the field of the webpage/interface that requests entry of the one-time password. After processing of the one-time password, transaction processing application 120 may then broadcast, through audio communications that may also be encrypted using the account identifier or other key, an acknowledgement response for second user device 130. The acknowledgement response may request that second user device 130 stop broadcasting the one-time password. Transaction processing application 120 may also deactivate a microphone of first user device 110 that was used to receive the one-time password. Transaction processing application 120 may then display the results of transaction processing, including any transaction history for the transaction. Transaction processing application 120 may also be used to access a digital wallet having the user's payment instruments, as well as establish two-factor authentication for payment instruments.

Audio input/output components 112 may correspond to one or more audio components configured to transmit and receive the audio communications discussed herein. In this regard, audio input/output components 112 may include one or more microphones capable of detecting and receiving audio communications, including infrasonic, ultrasonic, and/or audible audio communications. Other types of audio detection components may also be utilized, including infrasonic and/or ultrasonic audio detectors, which may be separate from a voice microphone utilized by first user device 110. For example, other types of pressure sensors may be capable of detection of other types of vibrational (e.g., pressure or compression waves through a medium) that may be outside of the detection range of a voice microphone. Audio input/output components 112 may also include one or more speakers capable of transmitting infrasonic, ultrasonic, and/or audible audio communications. Audio input/output components 112 may be utilized by transaction processing application 120 during a two-factor authentication process to broadcast a handshake request and/or acknowledgement response as audio communications, as well as receive audio communications including a one-time password.

In various embodiments, first user device 110 includes other applications 114 as may be desired in particular embodiments to provide features to first user device 110. For example, other applications 114 may include security applications for implementing client-side security features, programmatic client applications for interfacing with appropriate application programming interfaces (APIs) over network 170, or other types of applications. Other applications 114 may also include additional communication applications, such as email, texting, voice, and IM applications that allow a user to send and receive emails, calls, texts, and other notifications through network 170. In various embodiments, other applications 114 may include financial applications, such as banking, online payments, money transfer, or other applications, which may be utilized to maintain a user account with transaction processor server 150. Other applications 114 may also include other location detection applications, such as a mapping, compass, and/or GPS application, which may be used to determine a location for first user device 110. Other applications may include social networking applications and/or merchant applications. Other applications 114 may include device interfaces and other display modules that may receive input and/or output information. For example, other applications 114 may contain software programs, executable by a processor, including a graphical user interface (GUI) configured to provide an interface to the user.

First user device 110 may further include database 116 stored on a transitory and/or non-transitory memory of first user device 110, which may store various applications and data and be utilized during execution of various modules of first user device 110. Database 116 may include, for example, IDs such as operating system registry entries, cookies associated with transaction processing application 120 and/or other applications 114, IDs associated with hardware of first user device 110, or other appropriate IDs, such as IDs used for payment/user/device authentication or identification. Database 116 may store information for authentication of an account, such as identifiers, tokens, cookies, and/or authentication provided to first user device 110 from transaction processor server 150. Additionally, data necessary for performing a two-factor authentication through audio communications may be stored on database 116, including handshake data for a handshake request, an account identifier or other security key for encryption of data, information necessary to encode data into audio communications, and/or a received one-time password from received audio communications.

First user device 110 includes at least one communication module 118 adapted to communicate with second user device 130 and/or transaction processor server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Second user device 130 may be implemented as a communication device that may utilize appropriate hardware and software configured for wired and/or wireless communication with first user device 110 and/or transaction processor server 150. For example, in one embodiment, second user device 130 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may be used and function similarly.

Second user device 130 of FIG. 1 contains a digital wallet application 140, audio input/output components 132, other applications 134, a database 136, and a communication module 138. Digital wallet application 140 and other applications 134 may correspond to executable processes, procedures, and/or applications with associated hardware. In other embodiments, second user device 130 may include additional or different modules having specialized hardware and/or software as required.

Digital wallet application 140 may correspond to one or more processes to execute software modules and associated devices of second user device 130 to provide a digital wallet for electronic transaction processing through transaction processor server 150 using one or more payment or financial instruments stored to the digital wallet, where digital wallet application 140 may further assist in providing a one-time password for two-factor authentication to first user device 110 using audio communications. In this regard, digital wallet application 140 may correspond to specialized hardware and/or software utilized by a user to generate and maintain a digital wallet having payment instruments with an online financial entity, such as a bank for a debit/credit card and/or checking/saving account. A user may provide personal and/or financial information to establish the account and store financial instruments to the digital wallet. For example, the user may provide user information (e.g., name, shipping address, birthdate, and/or other consumer specific information) and/or financial information (e.g., a financial account, shipping address, etc.). Additionally, digital wallet application 140 may be used to process transactions using the digital wallet. Thus, digital wallet application 140 may include a dedicated application of transaction processor server 150 or other entity, which may be configured to send and receive electronic communications and engage in electronic transaction processing. When using digital wallet application 140 to establish and maintain a digital wallet, second user device 130 may become registered with the digital wallet so that second user device 130 is known, identifiable, and able to be communicated with over network communications. Therefore, second user device 130 may be registered to receive a one-time password during two-factor authentication when using a payment instrument in the digital wallet.

Digital wallet application 140 may be used to provide one or more authentication mechanisms with first user device 110, including a two-factor authentication mechanism that includes a one-time password being transmitted from second user device 130 to first user device 110 using audio communications. Digital wallet application 140 may communicate over a communication channel with transaction processor server 150 (e.g., secure TCP/IP communications between second user device 130 and transaction processor server 150) in order to receive the one-time password. For example, during transaction processing, digital wallet application 140 may display the checkout interface that requires a one-time password to be entered to a field of a two-factor authentication process. Once displayed, the one-time password may be sent to second user device 130 for audio communication to first user device 110. The password may be sent as text or a code that is unencrypted and not in an audio communication, or an audio file may be received that includes the password encrypted and/or encoded into an audio pattern. Thus, in certain embodiments, digital wallet application 140 may encode the password into an audio pattern, code, or other audio data that has the password data within the audio communications. The audio communications may be infrasonic, ultrasonic, or within the range of human hearing. Digital wallet application 140 may also encrypt the password, for example, using a shared secret between second user device 130 and second user device 130.

After receiving the one-time password, digital wallet application 140 may activate a microphone to begin listening for a handshake request through audio communications from first user device 110. In other embodiments, digital wallet application 140 may activate a different audio detection component than a voice microphone of second user device 130, such as an infrasonic or ultrasonic audio detection component used to detect audio signals outside of normal human speaking or hearing ranges. After detecting an audio communication, digital wallet application 140 may attempt to decode and decrypt the audio communication to verify that first user device is within range and transmitting the handshake request for the one-time password. If digital wallet application 140 is unsuccessful, digital wallet application 140 may discard the received audio data. However, if digital wallet application 140 is able to determine that first user device 110 is attempting a handshake with second user device 130, digital wallet application 140 may begin broadcasting the audio communications having the one-time password encoded into the audio communications. First user device 110 may then receive the audio communications having the one-time password, and may process as discussed herein. In other embodiments, when receiving the one-time password, digital wallet application 140 may instead generate an encrypted handshake request using handshake data, and may instead begin transmitting the handshake request. Once detected and verified by first user device 110, digital wallet application 140 may receive confirmation through audio communication and begin transmitting the audio communications having the one-time password.

After processing the one-time password, digital wallet application 140 may then receive, through audio communications that may also be encrypted using the account identifier or other key, an acknowledgement response from first user device 110. The acknowledgement response may request that second user device 130 stop broadcasting the one-time password. Digital wallet application 140 may deactivate the microphone of second user device 130, and may end broadcasting of the one-time password through the audio communications. Digital wallet application 140 may also communicate with transaction processor server 150 to complete the two-factor authentication request if required.

Audio input/output components 132 may correspond to one or more audio components configured to transmit and receive the audio communications discussed herein. In this regard, audio input/output components 132 may include one or more microphones capable of detecting and receiving audio communications, including infrasonic, ultrasonic, and/or audible audio communications. Other types of audio detection components may also be utilized, including infrasonic and/or ultrasonic audio detectors, which may be separate from a voice microphone utilized by second user device 130. For example, other types of pressure sensors may be capable of detection of other types of vibrational (e.g., pressure or compression waves through a medium) that may be outside of the detection range of a voice microphone. Audio input/output components 132 may also include one or more speakers capable of transmitting infrasonic, ultrasonic, and/or audible audio communications. Audio input/output components 132 may be utilized by digital wallet application 140 during a two-factor authentication process to receive a handshake request and/or acknowledgement response as audio communications, as well as broadcast audio communications including a one-time password.

In various embodiments, second user device 130 includes other applications 134 as may be desired in particular embodiments to provide features to second user device 130. For example, other applications 134 may include security applications for implementing client-side security features, programmatic client applications for interfacing with appropriate application programming interfaces (APIs) over network 170, or other types of applications. Other applications 134 may also include additional communication applications, such as email, texting, voice, and IM applications that allow a user to send and receive emails, calls, texts, and other notifications through network 170. In various embodiments, other applications 134 may include financial applications, such as banking, online payments, money transfer, or other applications, which may be utilized to maintain a user account with transaction processor server 150. Other applications 134 may also include other location detection applications, such as a mapping, compass, and/or GPS application, which may be used to determine a location for second user device 130. Other applications may include social networking applications and/or merchant applications. Other applications 134 may include device interfaces and other display modules that may receive input and/or output information. For example, other applications 134 may contain software programs, executable by a processor, including a graphical user interface (GUI) configured to provide an interface to the user.

Second user device 130 may further include database 136 stored on a transitory and/or non-transitory memory of second user device 130, which may store various applications and data and be utilized during execution of various modules of second user device 130. Database 136 may include, for example, IDs such as operating system registry entries, cookies associated with digital wallet application 140 and/or other applications 134, IDs associated with hardware of second user device 130, or other appropriate IDs, such as IDs used for payment/user/device authentication or identification. Database 136 may store information for authentication of an account, such as identifiers, tokens, cookies, and/or authentication provided to second user device 130 from transaction processor server 150, including information for a digital wallet. Additionally, data necessary for performing a two-factor authentication through audio communications may be stored on database 136, including a received handshake request, an account identifier or other security key for encryption of data, information necessary to encode data into audio communications, and/or a received one-time password from transaction processor server 150.

Second user device 130 includes at least one communication module 138 adapted to communicate with second user device 130 and/or transaction processor server 150. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor server 150 may be maintained, for example, by a transaction processing service provider, which may include payment processing providers and other type of financial service providers, as well as account services. In this regard, transaction processor server 150 includes one or more processing applications which may be configured to interact with first user device 110, second user device 130, and/or another device/server to facilitate account setup and transaction processing for financial transactions, as well as account and digital wallet use and maintenance. In one example, transaction processor server 150 may be provided by PAYPAL®, Inc. of San Jose, Calif., USA. However, in other embodiments, transaction processor server 150 may be maintained by or include another account provider entity and/or financial entity.

Transaction processor server 150 of FIG. 1 includes a two-factor authentication application 160, a transaction processing application 152, other applications 154, a database 156, and a network interface component 158. Two-factor authentication application 160, transaction processing application 152, and other applications 154 may correspond to executable processes, procedures, and/or applications with associated hardware. In other embodiments, transaction processor server 150 may include additional or different modules having specialized hardware and/or software as required.

Two-factor authentication application 160 may correspond to one or more processes to execute modules and associated specialized hardware of transaction processor server 150 to provide a two-factor authentication process and verify a one-time password for the process, which may include receipt of the password from an online financial entity, communication of the password to a registered device, and communication/verification of the password with the financial entity when received from another device. In this regard, two-factor authentication application 160 may correspond to specialized hardware and/or software to first receive checkout data from a checkout interface displayed on first user device 110. The checkout interface may correspond to an interface/website of a merchant engaged in a transaction with a user corresponding to first user device 110 through first user device 110. The checkout interface may allow the user to enter a payment instrument and/or use one or more payment instruments in a digital wallet. First user device 110 may transmit the payment data to transaction processor server 150, as well as any initial authentication or user information. Two-factor authentication application 160 may determine that a two-factor authentication process is required for processing the payment instrument. Two-factor authentication application 160 may output the two-factor authentication process on first user device 110, for example, in a webpage or interface of an application. In certain embodiments, an HTML inline frame element in a webpage of a merchant may display the process. Two-factor authentication application 160 may generate/determine the process, or may request the process and a corresponding one-time password from a financial entity associated with the financial instrument.

Two-factor authentication application 160 may further determine another device registered for or associated with the digital wallet and/or payment instrument. For example, second user device 130 may be registered with the digital wallet having one or more payment instruments used in the transaction requiring the two-factor authentication. Second user device 130 may therefore be set as the device to receive a one-time password for the two-factor authentication. Two-factor authentication application 160 may transmit the one-time password to second user device 130 for transmission through audio communications from first user device 110. Additionally, after receiving the one-time password from first user device 110 when entered to a field of the two-factor authentication process in the checkout experience on first user device 110, two-factor authentication application 160 may process the password. Processing the password may include verifying the password is the same as the generated password and/or communicating the password to the online financial entity associated with the payment instrument, where the online financial entity generated the password and verifies the password for the two-factor authentication process. Additionally, two-factor authentication application 160 may provide encoding and/or encrypting of data into one or more audio communications where not provided by first user device 110 and/or second user device 130. Two-factor authentication application 160 may also provide handshake data for a handshake between first user device 110 and second user device 130, as well as any encryption keys, such as an account identifier, used to protect data security during audio communications.

Transaction processing application 152 may correspond to one or more processes to execute modules and associated specialized hardware of transaction processor server 150 to receive and/or transmit information from first user device 110 for establishing payment accounts and digital wallets, as well as processing and completing of one or more transactions initiated by the user and using the payment account for transaction processing after authentication through two-factor authentication application 160, for example, through use of the digital wallet having one or more stored payment instruments. In this regard, transaction processing application 152 may correspond to specialized hardware and/or software to establish payment accounts and associated digital wallets, which may be utilized to send and receive payments and monetary transfers and engage in other financial transactions. The user associated with first user device 110 may establish a payment account with transaction processing application 152 by providing personal and/or financial information to transaction processor server 150 and selecting an account login, password, and other security information. In various embodiments, the financial information may include payment instrument information, such as account numbers. The user may directly provide the required account information, for example, during an account setup process. Transaction processing application 152 may then use the account for transaction processing. Two-factor authentication application 160 may be used to provide a two-factor authentication process for one or more payment instruments stored with a digital wallet for the account.

The account may be used to send and receive payments. The payment account may be accessed and/or used through a browser application and/or dedicated payment application executed by first user device 110 and/or second user device 130. Transaction processing application 152 may receive a payment request from first user device 110 and/or second user device 130 for a transaction between the user and the merchant, which may include identifiers, tokens, or other data used for transaction processing. Transaction processing application 152 may provide payment to the merchant using the payment instrument, and may provide a transaction history to first user device 110 and/or second user device 130, or store the history with one or more accounts. Thus, the account may be used as a payment instrument by transaction processor server 150 for transaction processing.

In various embodiments, transaction processor server 150 includes other applications 154 as may be desired in particular embodiments to provide features to transaction processor server 150. For example, other applications 154 may include security applications for implementing server-side security features, programmatic client applications for interfacing with appropriate application programming interfaces (APIs) over network 170, or other types of applications. Other applications 154 may contain software programs, executable by a processor, including a graphical user interface (GUI), configured to provide an interface to the user when accessing transaction processor server 150. In various embodiments where not provided by transaction processing application 152, other applications 154 may include connection and/or communication applications.

Additionally, transaction processor server 150 includes database 156. As previously discussed, one or more of a user and a seller may establish a payment account including a digital wallet with transaction processor server 150. Accounts in database 156 may include entity information, such as name, address, birthdate, payment/funding information, additional user financial information, and/or other desired user data. An entity may link to their respective accounts through an account, user, merchant, and/or device ID, as well as a generated token/cookie, which may be provided to first user device 110 and/or second user device 130 for use. Additionally, two-factor authentication information may be stored on database 156, such as a process and/or password used for the authentication.

In various embodiments, transaction processor server 150 includes at least one network interface component 158 adapted to communicate first user device 110 and/or second user device 130 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

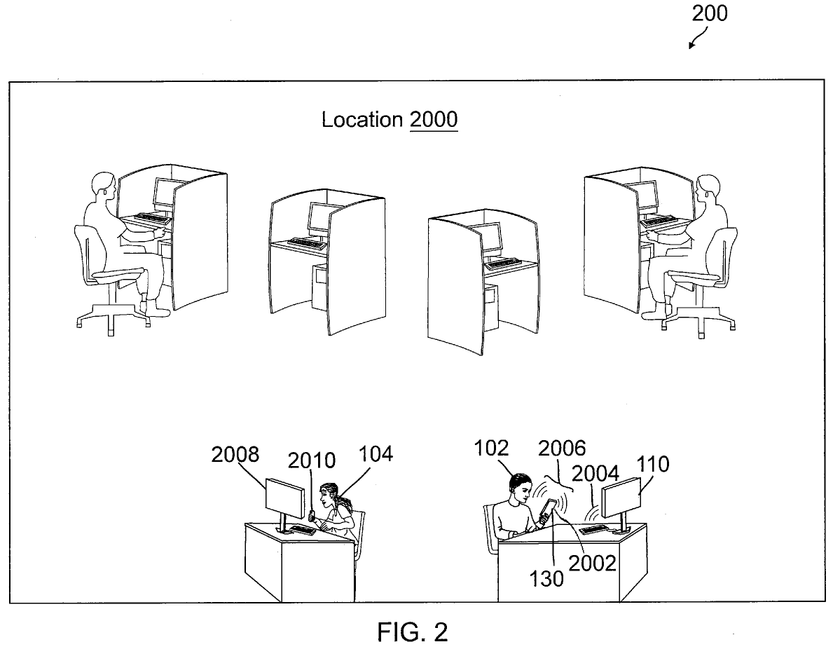

FIG. 2 is an exemplary real-world environment where a user may utilize ultrasonic or other audio communications between two devices to perform two-factor authentication without interfering with another device, according to an embodiment. FIG. 2 includes first user device 110 and second user device 130 discussed in reference to system 100 of FIG. 1.

In this regard, a first user 102 may be at a location 2000 in environment 200 where the user is performing an electronic transaction through an application on first user device 110. Environment 200 includes a second user 104 who may also use a third device 2008 and a fourth device 2010 at location 2000. Second user 104 may utilize third device 2008 and fourth device 2010 to perform other electronic transaction processing, or may generally use third device 2008 and fourth device 2010 at location 2000 where third device 2008 and fourth device 2010 may receive audio communications. When first user device 110 arrives at a checkout page, an SMS message 2002 (or other message type) may be received by second user device 130, which may include a one-time password for two-factor authentication. Next, first user device 110 and second user device 130 may exchange audio communications 2004 and audio communications 2006 to establish a handshake and request a one-time password through audio communications. Second user device 130 may then broadcast through audio communications 2006 the one-time password to first user device 110 for processing, as discussed herein. Since first user device 110 and second user device 130 are within audio communication range for audio communications 2004 and audio communications 2006, first user device 110 and second user device 130 may exchange the data through audio communications, such as ultrasonic communications, that allow for the one-time password to be transmitted to first user device 110 for processing.

By using ultrasonic communications for two-factor authentication between first user device 110 and second user device 130, communication of a one-time password may be performed in a localized manner that is not detectable by normal voice recording microphones and further does not disrupt nearby users through audible audio output. Ultrasonic communications allow encoding of additional data into the sonic waveform through the use of audio encoding that allows for binary or other values to be transformed into an audio pattern, such as an audio sound wave. Thus, a known length or amplitude of the wave may correspond to one binary value while silence or zero amplitude may correspond to the other binary value. The audio encoding technology may utilize a coding scheme where text and/or data (e.g., numbers and/or symbols) are translated into binary values. Utilizing high frequency or ultrasonic waveforms allows for encoding of additional data and therefore higher data transmission speeds and/or additional data transfer. Moreover, audio communications require two devices to be within an audio range or proximity, and therefore provide improved security by ensuring that both devices are under the control of a single individual and one device has not been otherwise stolen or misappropriated.

However, third device 2008 and fourth device 2010 may also be within range to receive the audio communications. In order to prevent unwanted reception, first user device 110 may encrypt data in audio communications 2004 and second user device 130 may encrypt data in audio communications 2006. The encryption may be done with an account identifier known to first user device 110 and second user device 130. Thus, if third device 2008 and/or fourth device 2010 are malicious and listening for audio communications during transaction processing, third device 2008 and fourth device 2010 will be unable to decrypt data from audio communications 2004 and/or audio communications 2006, and may discard such messages or have the messages rendered useless by the third device and the fourth device.

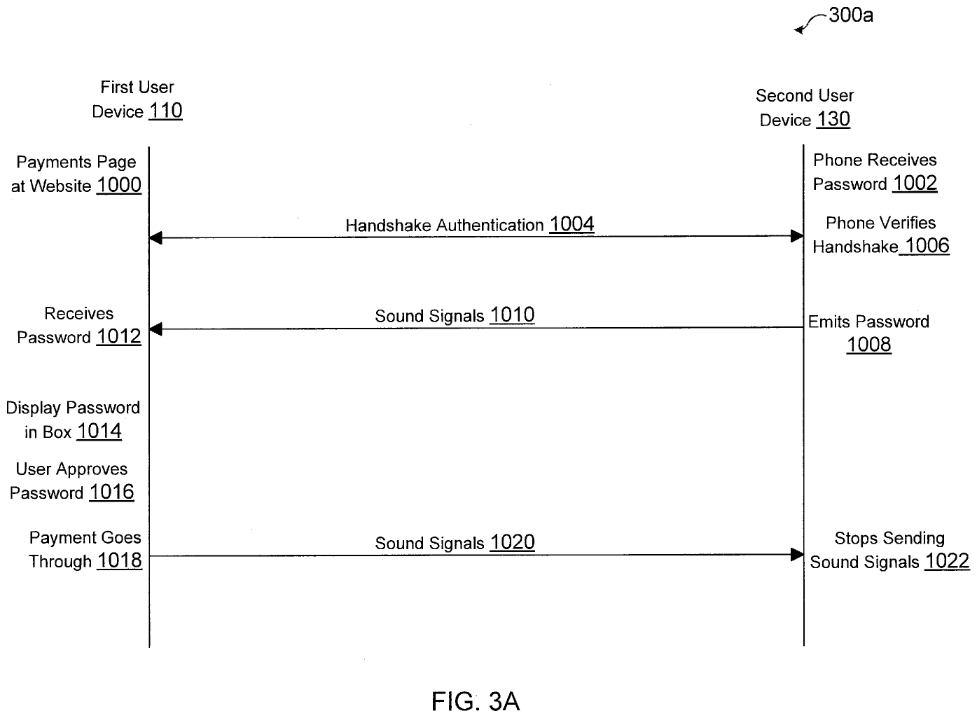

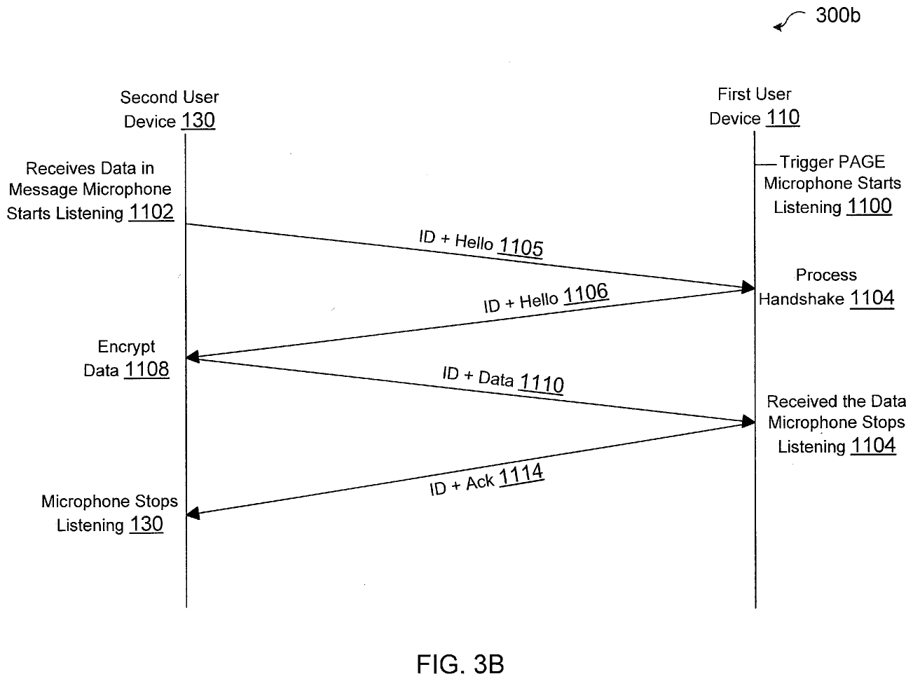

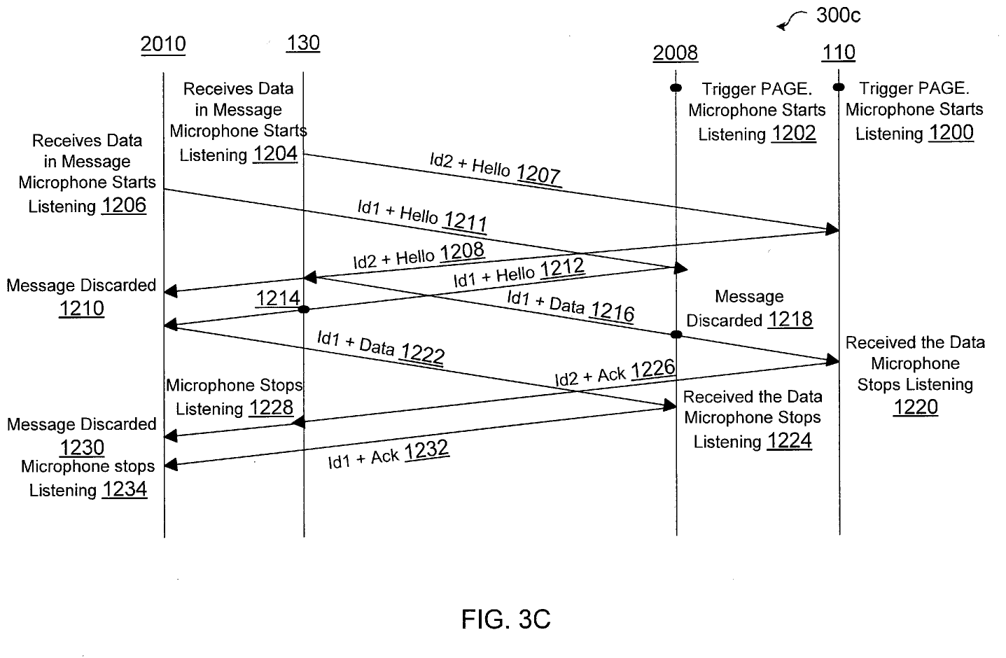

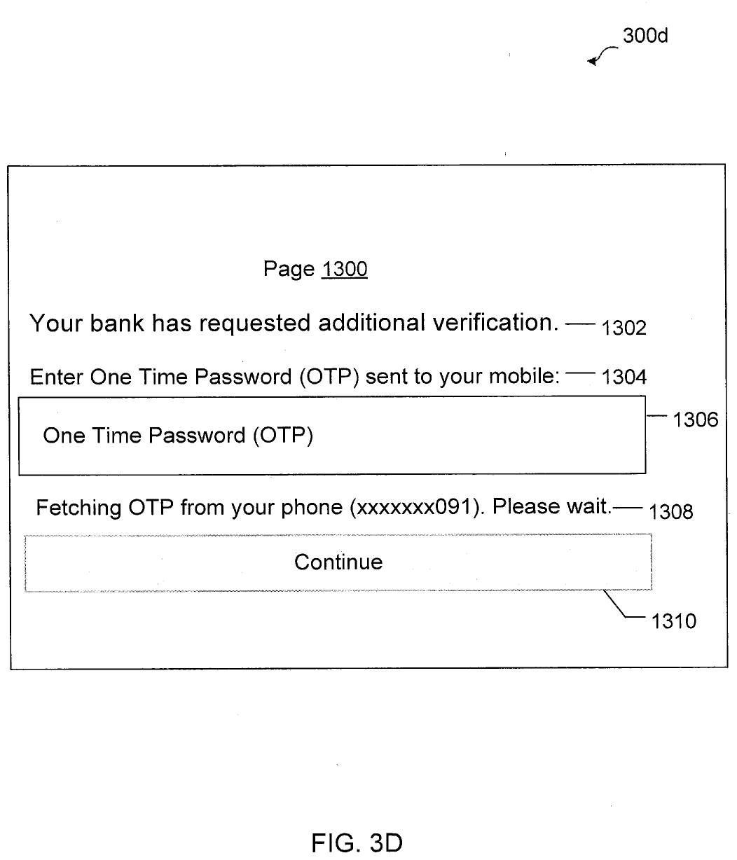

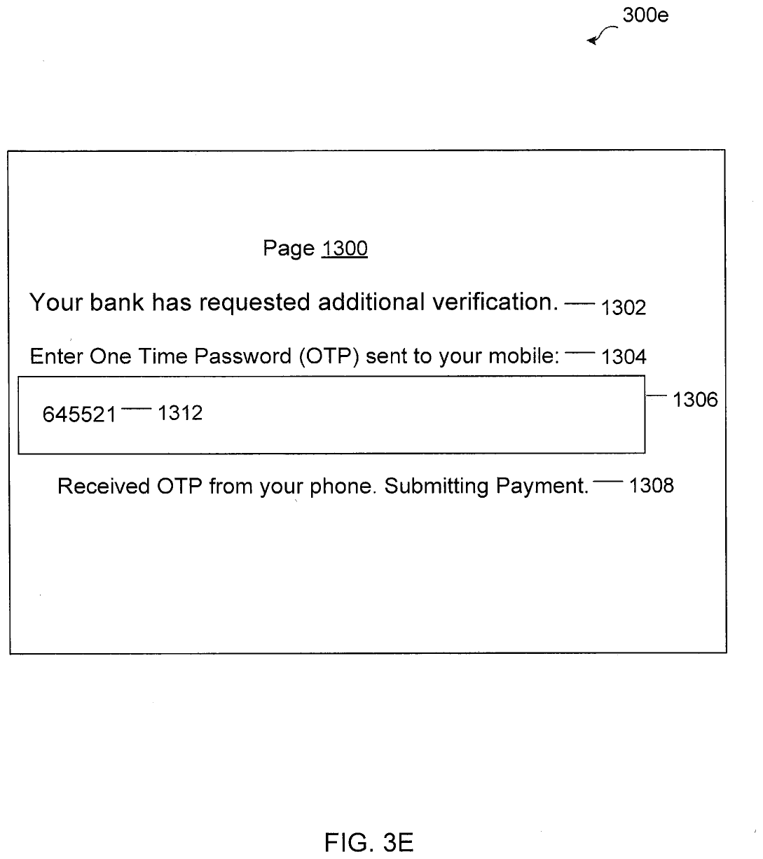

FIG. 3A is an exemplary communication flowchart for a simplified two-factor authentication process through ultrasonic communications, according to an embodiment. Note that one or more steps, processes, and methods described herein may be omitted, performed in a different sequence, or combined as desired or appropriate.

Communication flowchart 300a of FIG. 3A shows an overview of a process to perform two-factor authentication using two devices through ultrasonic (or otherwise) communications between the devices. First user device 110 and second user device 130 correspond generally to the described devices in system 100 of FIG. 1. First user device 110 may visit a payments page at a website at step 1000. The payments page may include one or more checkout or payment interfaces where a user may provide a payment instrument for use, for example, using a digital wallet with a payment provider. The payment provider and/or a financial entity associated with the payment provider may require two-factor authentication for use of the payment instrument. Additionally, in order to cause a password for the two-factor authentication to be sent from second user device, such as a mobile phone, to transmit the password for the two-factor authentication to first user device 110, the payment provider and/or financial entity may transmit the password to second user device 130 at step 1002. The payments page visited at step 1000 may cause sound signals to be emitted by first user device 110 at step 1004, where second user device 130, such as the mobile phone, receives the sound signals. The sound signals emitted at step 1004 may include a handshake authentication, where handshake data may be exchanged between first user device 110 and second user device 130. The handshake data may be encrypted using a shared secret or known data between first user device 110 and second user device 130, such as an account identifier.

At step 1006, second user device 130 may then verify that the handshake data in the sound signals emitted by first user device 110 and received by second user device 130 at step 1004 is known to second user device 130, including verifying that second user device 130 can decrypt the data using the agreed upon security mechanism. If so, at step 1010, second user device 130 emits sound signals that include the password received at step 1002. The password may also be encrypted in the sound signals. First user device 110 receives the password at step 1012, and proceeds to decode and/or decrypt the password from the sound signals. At step 1014, first user device 110 displays the password in the corresponding box for the two-factor authentication for user approval, which may include matching the password with one displayed by second user device 130. After user approval of the password at step 1016, a payment may go through on the payments page at step 1018. First user device 110 may then emit sound signals at step 1020 that include an acknowledgement response of the processed password and completed two-factor authentication, as well as the completed payment. This may then cause second user device 130 to step sending sound signals at step 1022, as well as deactivate a microphone. Additionally, after transmitting the sound signals at step 1020, first user device 110 may deactivate a microphone and stop transmitting the sound signals after a certain period of time sufficient to allow reception by second user device 130.

FIG. 3B is an exemplary communication flowchart for performing a handshake and transmitting a one-time password for two-factor authentication through ultrasonic communications when two associated devices for an account are present, according to an embodiment. Note that one or more steps, processes, and methods described herein may be omitted, performed in a different sequence, or combined as desired or appropriate.

Communication flowchart 300b shows an exemplary process between two user devices similar to communication flowchart 300a of FIG. 3A. In this regard, communication flowchart 300b shows an exemplary data exchange to perform two-factor authentication by exchanging handshake data and, once verified, broadcasting a two-factor authentication password through audio/sound communications, such as ultrasonic communications. First user device 110 and second user device 130 correspond generally to the described devices in system 100 of FIG. 1. First user device 110 may initiate the process by requiring two-factor authentication when a trigger page is visited at step 1100, where first user device 110 activates a microphone or other audio input/reception device or component. The trigger page may correspond to a checkout webpage for a transaction that is processed using a payment instrument that requires two-factor authentication. The trigger page may be displayed as an inline frame HTML element within another webpage, or may be a single webpage that displays a two-factor authentication process. In response to visiting the webpage, second user device 130 may then receive data for a one-time password used in the two-factor authentication, and may similarly activate a microphone or other audio input component, at step 1102.

At step 1104, first user device 110 may process handshake data, for example, using an account identifier or number that is known to the user(s) of both first user device 110 and second user device 130. In order to process handshake data, first user device may perform one of two processes. Second user device 130 may, in certain embodiments, encrypt handshake data and encode the encrypted data into an audio pattern, which second user device 130 may broadcast to first user device 110 at step 1105. First user device 110 may process the handshake data by decrypting using the account identifier and confirming the handshake data. In response, first user device 110 may transmit a notification or response to second user device 130 that requests second user device 130 transmit the password, at step 1106.

However, first user device 110 may also initiate the handshake request in other embodiments. First user device 110 may encrypt the handshake data using the account identifier. First user device 110 may then begin broadcasting the encrypted handshake data, at step 1106, using a speaker or other audio output component. In certain embodiments, the audio communications may be infrasonic or ultrasonic to minimize disruption and unwanted sound for nearby people. After receiving the handshake data and verifying the handshake data, for example, by decrypting the handshake data using the account identifier/number and verifying a hot word or other handshake data in the encrypted handshake, second user device 130 may then encrypt the received password data, at step 1108, which may be encrypted using the account identifier/number. Second user device 130 may broadcast the encrypted password data, at step 1110, using audio communications. Such communications may be similarly infrasonic/ultrasonic to avoid disruption.

First user device 110 may receive the encrypted password data, at step 1112, and may further disable the microphone or other audio input component. First user device 110 may process the received data, for example, by decrypting the password and inputting the password to a field for the two-factor authentication process. In other embodiments, the data may be communicated to a server for processing with the two-factor authentication process. In order to discontinue broadcasting of the password by second user device 130, first user device 110 may then transmit an acknowledgement of receipt and processing of the two-factor authentication password, at step 1114. This may also cause second user device 130 to deactivate a corresponding microphone or audio input component, as well as end broadcasting of the audio data having the password, at step 1116.

FIG. 3C is an exemplary communication flowchart for performing a handshake and transmitting a one-time password for two-factor authentication through ultrasonic communications when multiple associated device for multiple accounts are present, according to an embodiment.

Communication flowchart 300c shows an exemplary process with multiple devices that exchange data to perform two-factor authentication, as well as discard unusable data that may be received from other audio communications. First user device 110 and second user device 130 correspond generally to the described devices in system 100 of FIG. 1. Communication flowchart 300c further includes third device 2008 and fourth device 2010 corresponding generally to the described devices in environment 200 of FIG. 2. Thus, third device 2008 and fourth device 2010 may be within audio range to receive audio communications from first user device 110 and second user device 130, such as within the same room or location. Further, third device 2008 and fourth device 2010 are also exchanging data through audio communications in communication flowchart 300c, and therefore first user device 110 and second user device 130 may receive such audio communications from third device 2008 and fourth device 2010. In order to prevent unauthorized data reception and use, as well as avoid utilizing data that does not correspond to the two-factor authentication process being performed by two corresponding devices, communication flowchart 300c displays an exemplary data exchange that prevents such issues.

At step 1200, first user device 110 visits a trigger page that requires two-factor authentication and activates a microphone. This may then cause second user device 130 to receive password data for the two-factor authentication process on first user device 110 and activate a microphone on second user device 130, at step 1204. Similarly, third device 2008 visits a trigger page that also requires two-factor authentication and activates a microphone, at step 1202, which also causes fourth device 2010 to receive corresponding password data, at step 1206. At step 1208, first user device 110 processes a handshake request using audio communications by transmitting data to second user device 130, which may be encrypted by the account identifier or other encrypting key shared with second user device 130. This may include directly transmitting an encrypted handshake request to second user device 130 or replying to an encrypted handshake request transmitted from second user device 130 at step 1207. The handshake data transmitted at step 1207 and/or step 1208 may be received and may be verified. These messages may also be received by fourth device 2010, at step 1210. However, since fourth device 2010 does not include an encryption key (e.g., the account identifier shared between first user device 110 and second user device 130), fourth device 2010 may be unable to decrypt the data and verify the handshake, rendering the data unusable by the fourth device. Thus, fourth device 2010 may discard the data, at step 1210.

Third device 2008 may also process encrypted handshake data using a shared secret with fourth device 2010, at step 1212. As previously discussed, this may include initiating the handshake by transmitting, by third device 2008, encrypted handshake data to fourth device 2010 at step 1212, or by receiving encrypted handshake data from fourth device 2010, at step 1211, decrypting and verifying the data, acknowledging the handshake, and requesting the password, at step 1212. Second user device 130 may receive the broadcasted handshake from third device 2008, but may also discard the data because second user device 130 cannot decrypt the handshake data and verify it, at step 1214. In response to receiving and verifying the handshake data from first user device 110, second user device 130 may transmit encrypted password data for the two-factor authentication process to first user device 110, at step 1216. Third device 2008 may receive the broadcasted message from second user device 130, but may discard the data when third device 2008 is unable to decrypt the data, at step 1218. In contrast, first user device 110 may receive the encrypted password data in the audio communications from second user device 130, at step 1220, and may verify the data by using the shared secret with second user device 130. First user device 110 may receive and process the data after decrypting and/or verifying, and may deactivate the microphone of first user device 110.

Fourth device 2010 may also broadcast encrypted password data for the two-factor authentication on third device 2008, at step 1222. Since first user device 110 has already deactivated its microphone, first user device 110 may not receive the data. However, if the microphone of first user device 110 is still active, first user device 110 may discard the data after it is unable to decrypt the data. Third device 2008 may receive the data from fourth device 2010, at step 1224, and may decrypt/verify the data using the shared secret (e.g., account identifier) with fourth device 2010. Additionally, third device 2008 may also deactivate its microphone at step 1224. First user device 110 may then transmit an acknowledgement audio signal to second user device 130 to acknowledge receipt and processing of the audio communication having the password needed for the two-factor authentication, at step 1226. Second user device 130 may receive the acknowledgement, at step 1228, and may deactivate its microphone and end broadcasting of the audio communications. Fourth device 2010 may also receive the acknowledgement, but as fourth device 2010 cannot verify the acknowledgement, fourth device 2010 may discard the data, at step 1230. Third device 2008 may also transmit an acknowledgement audio communication for fourth device 2010, at step 1232, which may cause fourth device 2010 to deactivate its microphone and end broadcasting of the audio communications, at step 1234.

FIG. 3D is an exemplary application interface requesting a one-time password for two-factor authentication through ultrasonic communications, according to an embodiment. Environment 300d of FIG. 3D includes exemplary screenshots displayed during two-factor authentication using two devices through audio communications. In this regard, environment 300d displays a two-factor authentication process in an HTML inline frame element from a website, where page 1300 includes an authentication interface for the two-factor authentication process.

A page 1300 includes a requested two-factor authentication message 1302 by a bank when using a payment instrument that requires two-factor authentication for transaction processing. A financial entity may request a one-time password to be entered that is communicated to a known device established for the two-factor authentication. For example, a one-time password message 1304 may alert a user that a one-time password is sent to the mobile device. This may alert the user to place the mobile device within audio range of the computing device displaying page 1300. Page 1300 may include a password field 1306 for entry of the one-time password. However, in order to provide hands free entry of the password (e.g., without having to input the password through user input, such as keystrokes or interface touch input), page 1300 may provide an audio communication alert 1308 for an audio communication process that provides the one-time password from the mobile device to the computing device through audio communications. Once password field 1306 is populated, the user may request processing through section of continue option 1310.

FIG. 3E is an exemplary application interface after entering a one-time password for two-factor authentication received through ultrasonic communications, according to an embodiment. Environment 300e of FIG. 3E includes exemplary screenshots displayed after two-factor authentication using two devices through audio communications. In this regard, environment 300e displays a two-factor authentication process in an HTML inline frame element from a website, where page 1300 displays messages after processing a one-time password.

Page 1300 displays an entered one-time password through audio communications and a correspond payment processed based on completing the two-factor authentication in page 1300 through the entered password. Two-factor authentication message 1302 is updated based on a one-time password 1312 entered to password field 1306. After entry of one-time password 1312 to password field 1306, one-time password 1312 may be processed by a payment processor/financial entity requiring the one-time password for the two-factor authentication process. A completion message 1314 may display that one-time password 1312 is processed, and a payment is being completed using the corresponding payment instrument.

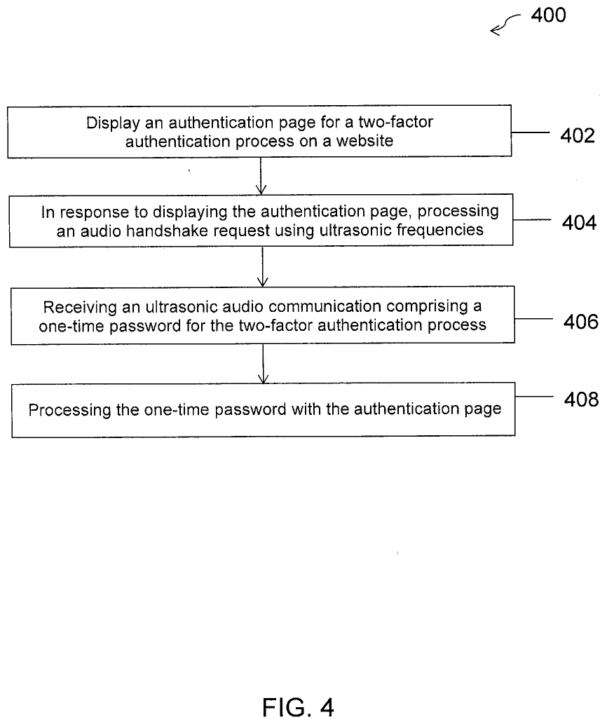

FIG. 4 is an exemplary process flowchart for two-factor authentication through ultrasonic audio transmissions, according to an embodiment. Note that one or more steps, processes, and methods described herein may be omitted, performed in a different sequence, or combined as desired or appropriate.

At step 402 of flowchart 400, an authentication page for a two-factor authentication process on a website is displayed, for example, by a first user device system. In response to displaying the authentication page, an audio handshake request is processed using ultrasonic frequencies, at step 404 of flowchart 400. Prior to processing the audio handshake request, the first user device system may activate a microphone or other audio detection component. The audio handshake request may be processed in one of two ways. First, the audio handshake request may be received by the first user device system from the second user device system through audio communications (e.g., ultrasonic communications). The first user device system may confirm the handshake request by decrypting the handshake request and verifying the data, and may then transmit a confirmation and request for the one-time password to the second user device system through audio communications. In other embodiments, the audio handshake request may be received from a service provider over a network. In other embodiments, instead an account identifier for an account used by the first user device system with one or more other devices, such as a second user device system, may be determined from account information for the account, and the audio handshake request may be generated using the account identifier and handshake data associated with an application on the second user device system. For example, the first user device system and the second user device system may both be registered for the account through an online service provider.

An ultrasonic audio communication comprising a one-time password for the two-factor authentication process is received, at step 406 of flowchart 400, for example, from a second user device system. This password may be encrypted using an account identifier for the account. The password may be generated by an online banking service associated with a selected funding instrument for the use of the account on the website. Thus, this password may be one-time use and randomly generated for the particular authentication request on the authentication page.

When receiving the one-time password, the second user device system may also perform certain operations. For example, the password or other passcode may be received by the second user device system in response to the first user device system accessing the authentication page, such as during a checkout flow on the website. An audio detection component on the second user device system may be activated and configured to detect ultrasonic sound. The audio handshake request may first be transmitted by the second user device system, for example, when the second user device system received the one-time password. The first user device system may confirm the handshake and respond to the handshake by requesting transmission of the one-time password. In other embodiments, the audio handshake request may instead be transmitted by the first user device system and then received by the second user device system from the first user device system, which may be verified, for example, by decrypting data in the audio communications having the audio handshake request using an account identifier for an account used by the second user device system. In response to verifying, the second user device system may begin transmitting or broadcasting the one-time password using ultrasonic communications. In order to transmit the password, the password may be encrypted by the second user device system using an account identifier (e.g., using a mobile application, such as and electronic transaction processing application that utilizes the account identifier to process transactions using the account). The encrypted based may then be encoded into an audio pattern.

At step 408 of flowchart 400, the one-time password is processed with the authentication page. Processing the authentication request within the authentication page may comprise one of transmitting the audio communication with the password to a server hosting the website for processing or decoding the encrypted password from the audio communication, decrypting the password from the encrypted password, and entering the password to the field of the authentication page. Thus, in certain embodiments, processing the authentication request may include verifying that the audio communication is encrypted using an account identifier for the account, wherein the account identifier is stored on the first user device system.

In various embodiments, flowchart 400 may further include deactivating the audio input component in response to receiving the audio communication and transmitting an acknowledgement audio communication to the second user device system, wherein the acknowledgement audio communication comprises a termination request that the second user device system end an audio listening process executing on the second user device system.

A service provider may also interact with the first and second user device systems to provide certain functionality when performing the two-factor authentication. For example, the service provider may receive an authentication request for an account that uses a payment instrument that requires two-factor authentication, for example, during the checkout process on the website accessed by the first user device system The service provider may determine that such an authentication request requires the two-factor authentication, and may cause a webpage, field, or other data to be displayed on the first user device system within the website for entry of the password for the two-factor authentication. Displaying data within another website may use an inline frame element on a webpage of the website, wherein the inline frame element automatically enters the password to a field within the element based on ultrasonic communications. The service provider may then transmit the password to the second user device system, which may execute the aforementioned steps to communication the password to the first user device system. The password maybe generated by the service provider may be retrieved from a banking/financial entity associated with the payment instrument requiring the two factor authentication. In response to receiving the password from the first user device system using the displayed field, the service provider may then authenticate the use of the account on the website.

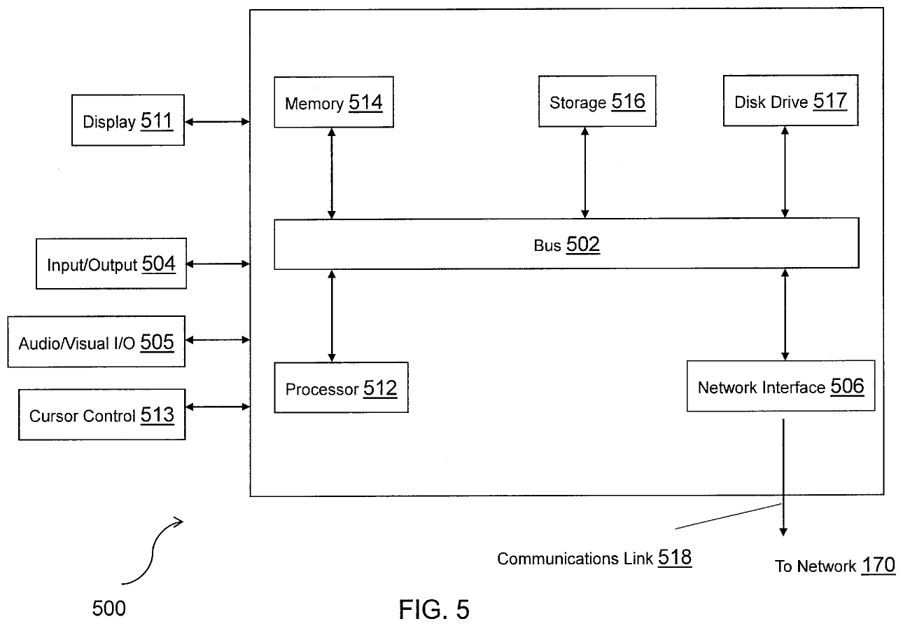

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A first user device system comprising:
an audio output component;
an audio input component;
a non-transitory memory; and
one or more hardware processors coupled to the non-transitory memory and configured to read instructions from the non-transitory memory to cause the first user device system to perform operations comprising:
determining an authentication request for authentication from a user through a web site;
in response to the determining, displaying an authentication page for a two-factor authentication process on the website, wherein the authentication page comprises a field for entry of a password generated for the two-factor authentication process, and wherein the password authenticates use of an account using the two-factor authentication process;
in response to displaying the authentication page, processing an audio handshake request;
receiving an audio communication from a second user device system, wherein the audio communication comprises the password encoded into the audio communication; and
processing the authentication request based on the audio communication.

2. The first user device system of claim 1, wherein the operations further comprise:
in response to receiving the audio communication, deactivating the audio input component; and
transmitting an acknowledgement audio communication to the second user device system, wherein the acknowledgement audio communication comprises a termination request that the second user device system end an audio listening process executing on the second user device system.

3. The first user device system of claim 1, wherein the password is encrypted using an account identifier for the account.

4. The first user device system of claim 3, wherein the processing the authentication request comprises one of transmitting the audio communication to a server hosting the website for processing or decoding the encrypted password from the audio communication, decrypting the password from the encrypted password, and entering the password to the field of the authentication page.

5. The first user device system of claim 1, wherein prior to the processing the audio handshake request comprises:
receiving the audio handshake request from the second user device system;
confirming the audio handshake request; and
transmitting a password transmission request for the password to the second user device system.

6. The first user device system of claim 1, wherein the processing the audio handshake request comprises:
determining an account identifier for the account from account information for the account;
generating the audio handshake request using the account identifier and handshake data associated with an application on the second user device system; and
broadcasting the audio handshake request for the second user device system.

7. The first user device system of claim 1, wherein the password is generated by an online banking service associated with a selected funding instrument for the use of the account on the website.

8. The first user device system of claim 1, wherein the first user device system and the second user device system are both registered for the account through an online service provider.

9. The first user device system of claim 1, wherein the processing the audio handshake request comprises one of broadcasting a first ultrasonic audio communication for the audio handshake request or receiving the first ultrasonic audio communication for the audio handshake request, and wherein the receiving the audio communication comprises receiving a second ultrasonic audio communication for the audio communication.

10. The first user device system of claim 1, wherein the processing the authentication request further comprises verifying that the audio communication is encrypted using an account identifier for the account, and wherein the account identifier is stored on the first user device system.

11. The first user device system of claim 1, wherein the password is a one-time use password randomly generated for the authentication request.

12. A method comprising:
receiving, using a mobile device, a limited use passcode for a two-factor authentication process during a checkout flow for a website accessed by a separate computing device;
activating an audio detection component of the mobile device, wherein the audio detection component is configured to detected ultrasonic sound;
transmitting, using the audio detection component of the mobile device, a first ultrasonic signal, wherein the first ultrasonic signal comprises a handshake request for audio communications with the separate computing device;
processing the handshake request with the separate computing device; and
transmitting the limited use passcode to the separate computing device using a second ultrasonic signal.

13. The method of claim 12, further comprising:
in response to the separate computing device receiving the limited use passcode, receiving a third ultrasonic signal comprising an acknowledgement message; and
deactivating the audio detection component of the mobile device based on the acknowledgement message.

14. The method of claim 12, further comprising, prior to the transmitting:
encrypting the limited use passcode using an account identifier for an account requiring the two-factor authentication process during the checkout flow; and
encoding the encrypted limited use passcode into an audio pattern for the second ultrasonic signal.

15. The method of claim 14, wherein the encrypting and the encoding is by a processor of the mobile device that executes an electronic transaction processing application associated with the account, and wherein the electronic transaction processing application comprises one or more executable processes to access the account through a network connection.

16. The method of claim 12, wherein prior to receiving the limited use passcode, the method further comprises:
accessing an account with a service provider using an application running on the mobile device,
wherein the limited use passcode is received by the mobile device from the service provider in response to the separate computing device processing a transaction using the account.

17. The method of claim 12, wherein the transmitting the handshake request comprises encrypting the handshake request using an account identifier for an account requiring the two-factor authentication process during the checkout flow.

18. A service provider system comprising:
a non-transitory memory; and
one or more hardware processors coupled to the non-transitory memory and configured to read instructions from the non-transitory memory to cause the service provider system to perform operations comprising:
receiving an authentication request for an account used on a website by a first device, wherein the authentication request is associated with a payment for a transaction using the account;
determining that the authentication request requires two-factor authentication for processing the payment;
displaying on the first device a webpage comprising a field for entry of a one-time use passcode for the two-factor authentication;
transmitting the one-time use passcode to a second device associated with the account; and
in response to receiving the one-time use passcode from the first device obtained through an ultrasonic communication from the second device, processing the authentication request based on the one-time use passcode.

19. The service provider system of claim 18, wherein the transmitting the one-time use passcode to the second device comprises one of generating, by the service provider system, the one-time use passcode and transmitting the one-time use passcode to the second device or requesting, by the service provider system, the one-time use passcode from an online banking entity and transmitting the one-time use passcode to the second device.

20. The service provider system of claim 18, wherein the displaying on the first device the webpage uses an inline frame element on the webpage, wherein the inline frame element automatically enters the one-time use passcode to the field based on the ultrasonic communication.
